(19) United States
(12) Patent Application Publication
(10) Pub. No.: US 2009/0030713 A1
(43) Pub. Date: Jan. 29, 2009

(54) System and method of reviewing ownership of and encumbrances on intellectual property assets

(76) Inventor: A.R. Venkatachalam, Exeter, NH (US)

Correspondence Address: DEVINE, MILLIMET & BRANCH, P.A., 111 AMHERST STREET, BOX 719, MANCHESTER, NH, 03105, US

(21) Appl. No.: 11/881,741

(22) Filed: Jul. 27, 2007

(51) Int. Cl. G06F 17/00; G06F 7/10; G06F 17/30; G06F 7/38

(52) U.S. Cl. 705/1; 707/3; 707/5; 708/205; 708/208; 708/236; 707/E17.017; 707/E17.019

(57) ABSTRACT

A review system and method gathers and analyzes data related to ownership of and encumbrances on intellectual property assets from relevant recordation locations. The system and method analyzes the data and interprets the data and the chain of ownership of intellectual property assets.

### GOVERNMENT LICENSE RIGHTS

The U.S. Government has a paid-up license in this invention and the right in limited circumstances to require the patent owner to license others on reasonable terms as provided for by the terms of contract number DOC50PAPT0501026 awarded by the U.S. Patent and Trademark Office.

### TECHNICAL FIELD

The present invention relates to the reviewing of documents and more particularly, to a system and method that queries multiple sources and reviews and analyzes the results to evaluate the ownership of and encumbrances on intellectual property assets.

### BACKGROUND INFORMATION

A company trying to raise capital to expand its business may raise capital based on the value of its patents. It may do so in a number of ways, including through an equity investment, a loan collateralized by patents, or a sale of patents.

A third party, a prospective source of capital or purchaser of intellectual property assets needs to review the ownership of, and encumbrances on, the intellectual property assets, such as a U.S. patent. The third party needs to review documents that assign, grant, or convey rights related to the intellectual property assets. There is no one single location for recording such documents.

The absence of an adequate mechanism to determine, through one system, both the ownership and any existing security interests in intangible assets creates uncertainty and risk to investors and increases the cost of capital to entrepreneurs.

### SUMMARY OF THE INVENTION

Unfortunately, there are deficiencies in conventional methods of reviewing ownership of and encumbrances on intellectual property assets that lead to missing relevant documents and/or misinterpretation of the information. Furthermore, there are both monetary and time costs associated with gathering the information.

In contrast to the above-described conventional methods of gathering and reviewing information, this system and method gathers and analyzes data from relevant sources. The system and method analyzes the data and interprets the data and the chain of ownership of intellectual property assets.

An embodiment of an assessment method of reviewing ownership of and encumbrances on intellectual property reviews a document associated with the recordation of transfer of ownership of an intellectual property asset. A value is assigned based on whether a criteria is met or is not related to the transfer of ownership of an intellectual property asset.

In an embodiment, the intellectual property asset is a patent or patent application. In an embodiment, only documents recorded with a federal agency are assessed.

In an embodiment of the assessment method, the evaluation or assessment is done on a specific set of criteria. The specific set of criteria in an embodiment includes determining if the intellectual property asset is assigned to a party of interest; determining if all the inventors assigned the intellectual property asset directly to the party of interest; and determining if the document associated with the recordation of transfer of ownership of the intellectual property asset was recorded within a specific time period.

The specific set of criteria further includes determining if a party assigned their entire interest in one embodiment. In an embodiment, the results of at least one criteria are capable of being manually overridden by a user.

One embodiment of the evaluation or assessment method further includes assigning a value based on whether at least one other criteria is met or is not related to the transfer of ownership of an intellectual property asset; and summing the values of a plurality of criteria to arrive at a score.

An embodiment of the evaluation or assessment method includes reviewing at least one additional document associated with the recordation of transfer of ownership of the intellectual property asset, and determining the score based on the average of the score for each document.

In an embodiment, a scaling factor is assigned to each document reviewed. In one embodiment, the scaling factor is identical for each document. In another embodiment, the scaling factor is linear and the oldest document in the chain has the highest value and the newest document in the chain has the lowest value. In a third embodiment, the scaling factor is quadric or exponential.

In an embodiment of the evaluation or assessment method, at least two intellectual property assets are evaluated and the score for each of the intellectual property assets is aggregated to give a portfolio score. Each intellectual property asset has a scaling factor associated with the asset. In an embodiment, the value of the scaling factor is dependent on the relationship of the intellectual property asset to the initial filed intellectual property asset. In an embodiment, the data is manually entered and a given a scaling constant.

A system for reviewing data includes an input device for receiving a request for information from a querying device for assessment of the information. The system has a querying mechanism for requesting and receiving information from at least one government entity database. An output device of the system presents at least some of the information gathered from at least one government entity database.

In an embodiment of the system, the information from the querying device is related to ownership of and encumbrances on intellectual property assets.

In an embodiment of the system, the request is related to a U.S. patent or patent application and at least one government entity database includes the U.S. Patent and Trademark office patent assignment database server. In another embodiment of the system, the request is related to a U.S. trademark or trademark application and at least one government entity database includes the U.S. Patent and Trademark office trademark assignment database server. In another embodiment of the system, the request is related to a property that has an underlying federal copyright registration and at least one government entity database is the U.S. Copyright office Registrations and Documents database server.

In an embodiment of the system, the querying mechanism includes fuzzy logic for increasing the likelihood of gathering all relevant information from at least one government entity database.

In an embodiment of the system, the government entity databases include at least one database controlled by the federal government and at least one database controlled by a non-federal agency. In an embodiment, at least one government entity database controlled by a non-federal agency is a UCC database of a state organization.

In an embodiment of the system, one of the government entity databases controlled by the federal government is the assignment database of the U.S. Patent and Trademark office.

In an embodiment of the system, the querying mechanism requests information based on a field of data. In an embodiment, the field of data searched is the inventor field. In an embodiment, the field of data searched is the intellectual property asset reference number field such as a patent or patent application number. In an embodiment, the field of data searched is the assignee field. In an embodiment, the field of data searched is the assignor field.

In an embodiment of the system, the information received from at least one government entity database is stored in a database for analysis. In an embodiment of the system, the information received from at least one government entity database is in an image format such as a jpeg, tiff, or pdf. In an embodiment of the system, the information received is converted from the image format to a character format.

A system for gathering and reviewing ownership of and encumbrances on intellectual property includes an input device for receiving a query from a querying device, the query in the form of a property identification number or a party. A querying mechanism requests and receives information from at least one government entity database based on the query. An analyzing mechanism analyzes the information from at least one government entity database. An output device presents the information and the analyses of the information.

An embodiment of a system for gathering and reviewing ownership of and encumbrances on intellectual property wherein the intellectual property is a patent or patent application. An embodiment of a system for gathering and reviewing ownership of and encumbrances on intellectual property wherein the querying mechanism includes fuzzy logic for increasing the likelihood of gathering all relevant information from at least one government entity database.

An embodiment of a system for gathering and reviewing ownership of and encumbrances on intellectual property wherein the analyzing mechanism assesses the information on a specific set of criteria.

An embodiment of a system wherein the specific set of criteria includes determining if the intellectual property asset is assigned to a party of interest; determining if all the inventors assigned the intellectual property asset directly to the party of interest; and determining if the document associated with the recordation of transfer of ownership of the intellectual property asset was recorded within a specific time period.

An embodiment of a system wherein the results of at least one criteria are capable of being manually overridden by a user. An embodiment of a system wherein the queried information is stored on a non-government computer and is capable of being modified and analyzed again.

An embodiment of a system wherein the analyzing mechanism assigns a value based on whether at least one other criteria is met or is not related to the transfer of ownership of an intellectual property asset; and sums the values of a plurality of criteria to arrive at a score.

An embodiment of a system for gathering and reviewing ownership of and encumbrances on intellectual property wherein the analyzing mechanism reviews at least one additional document associated with the recordation of transfer of ownership of the intellectual property asset, and determines the score based on the average of the score for each document. An embodiment of a system wherein a scaling factor is assigned to each document reviewed. An embodiment of a system wherein the scaling factor is linear and the oldest document in the chain has the highest value and the newest document in the chain has the lowest value.

An embodiment of a system for gathering and reviewing ownership of and encumbrances on intellectual property wherein the score (RCS) is represented by

$$R C S = {\sum }_{i = 1}^{m} {w}^{′} ( i ) \cdot R W S ( i ) ,$$

wherein
i is the number of assignments for a patent;
m is the total number assignments for a given patent;
w′(i) is the normalized value of adjusted weight, w(i); and
RWS(i) is the Row Weighted Score for each assignment, i. where

$$R W S ( i ) = {\sum }_{i = 1}^{m} k ( j ) \cdot X ( i , j )$$

wherein
   k(j) is the relative importance factor for the criteria; and
   X(i,j) takes on discrete values of 0 or 100 for each i and j.

An embodiment of the system wherein w(i)=−a(i−1)+b and a=−0.01 and b=0.2

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a functional block diagram illustrating a flow chart of the method of reviewing of ownership of and encumbrances on intellectual property assets, according to one embodiment of the present invention;

FIG. 2 is a schematic of the system connecting to third party systems;

FIG. 3 is a flow chart of analysis of an assignment;

FIG. 4 is a copy of an example of an assignment history for an intellectual property asset on a federal database;

FIG. 5 is a screen shot of an assignment history from the Rights Check System;

FIG. 6 is a screen shot of an assignment history from the Rights Check System with selected items overridden;

FIG. 7 is a screen shot of an assignment summary from the Rights Check System;

FIG. 8 is a flow chart of analysis of a security interest;

FIG. 9 is an example of the description of collateral; and

FIG. 10 is a schematic of providing a Rights Check Score for multiple intellectual property assets.

### DETAILED DESCRIPTION OF PREFERRED EMBODIMENTS

The review system and method gathers and analyzes data related to ownership of and encumbrances on intellectual property assets from relevant recordation locations. The system and method analyzes the data and interprets the data and the chain of ownership of intellectual property assets.

For ease of discussion, the detailed description will generally refer to a patent. It is recognized that the method and system is applicable also to trademarks and items that have federal registration of their copyright.

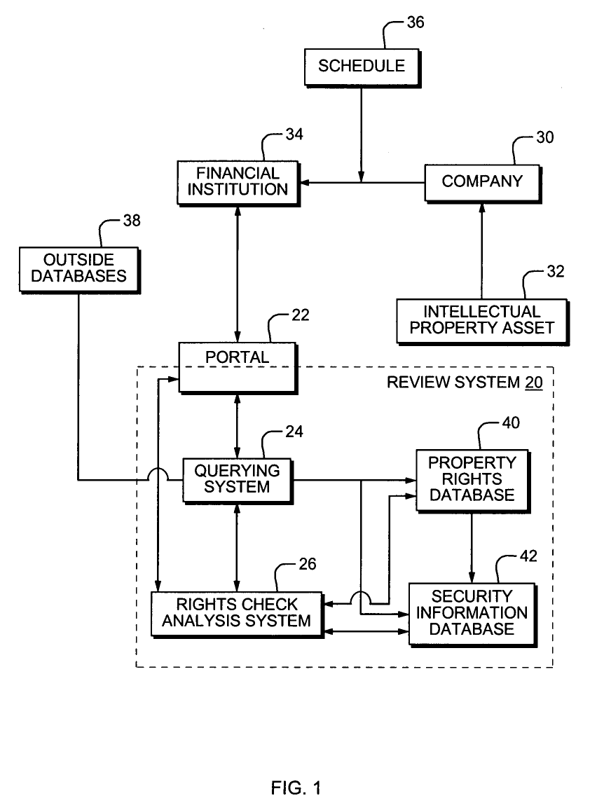

Referring to FIG. 1, a review system 20 having a portal 22, a querying system 24, and a rights check analysis system 26 according to the invention is shown. As part of explaining the review system 20 and method of use, an example will be provided. Those skilled in the art will recognize that the review system 20 has many other applications.

Still referring to FIG. 1, as way of an example, a company 30, (“Acme”), a Massachusetts corporation, is seeking additional capital to expand the capacity and scope of its business. The company 30 has at least one intellectual property asset 32, which in this example is a patent portfolio. The company 30 is considering the following, among other things, as ways to raise capital: 1) an equity investment based on the value of its patent portfolio, 2) a loan collateralized by its patent portfolio, or 3) the sale of part of its patent portfolio. As part of seeking additional capital, the company 30 provides the financial institution 34 an informal schedule 36 which may include various things including the intellectual property they own and liabilities that might effect rights in the intellectual property.

A financial institution 34, a prospective source of capital, needs to ensure that the financial institution 34 has a proper understanding of the ownership of and encumbrances on the underlying intellectual property assets 32 (i.e., the company's patent portfolio). The financial institution 34 uses the review system 20 to ascertain the ownership of and encumbrances on the underlying intellectual property assets 32.

The portal 22 of the review system 20 allows selected access to the querying system 24 and the rights check analysis system 26. The querying system 24 gathers information about ownership in a property right database 40 and a security information database 42 generally from at least one outside database 38. The rights check analysis system 26 of the review system 20 reviews the data 40 and 42 gathered. The financial institution 34 accesses the information on the review system 20 through the portal 22 to the financial institution 34 to assist the financial institution 34 in evaluating the intellectual property asset 32.

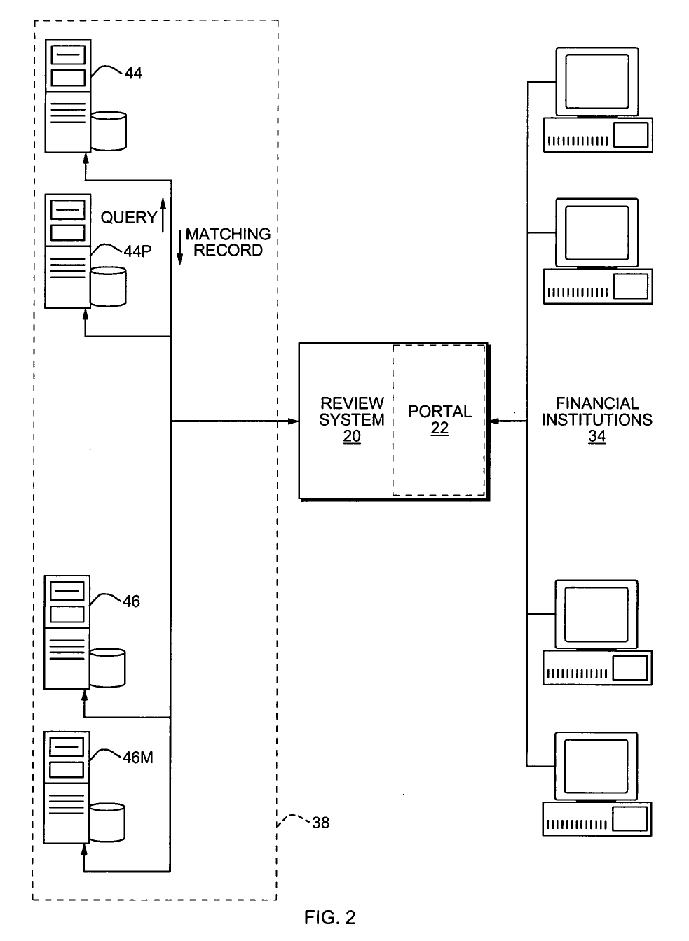

Referring to FIG. 2, a schematic of the review system 20 connecting to third party systems is shown. The review system 20 through a plurality of portals 22 is connected to the financial institution 34. While it is contemplated that in most instances that the portal will be connected through the internet, it recognized that there may be other forms of connection, including direct hardwire connection, dial direct connection, and other methods. The query is sent from a financial institution 34 to the review system 20. As explained below, the query will typically come in the form of intellectual property asset identification, such as a patent number or patent publication number, and a party of interest (e.g., the company 30, Acme).

The rights check analysis system 26, as shown in FIG. 1, of the review system 20 determines what third party database should be queried to gather data. The review system 20 is connected through a portal 22 to a plurality of outside databases 38 including both at least one federal database server 44, such as the U.S. Patent and Trademark Office Patent Assignment Database Server 44P (http://assignments.uspto.gov/assignrments/q?db=pat), and a plurality of non-federal, typically state database servers 46, such as the Massachusetts UCC database server 46M. (http://corp.sec.state.ma.us/corp/psearch/default.asp).

It is in the company's 30, Acme's, best interest to demonstrate it has title to the intellectual property assets 32, patents and patent applications. Customarily, the company 30, Acme, will provide the financial institution 34 with an abstract or informal schedule 36, as shown in FIG. 1, giving the details of the transfer of title to the patent(s) and/or patent application(s) to Acme. The financial institution 34 uses the review system 20 to confirm information in the informal schedule 36.

The arrows between the review system 20 and the outside databases 38, the federal database servers 44 and the non-federal state database servers 46, represent the query by the review system 20 and the data of the matching records. The financial institutions 34 provide the initial query and receive analysis from the review system 20 through the portal 22.

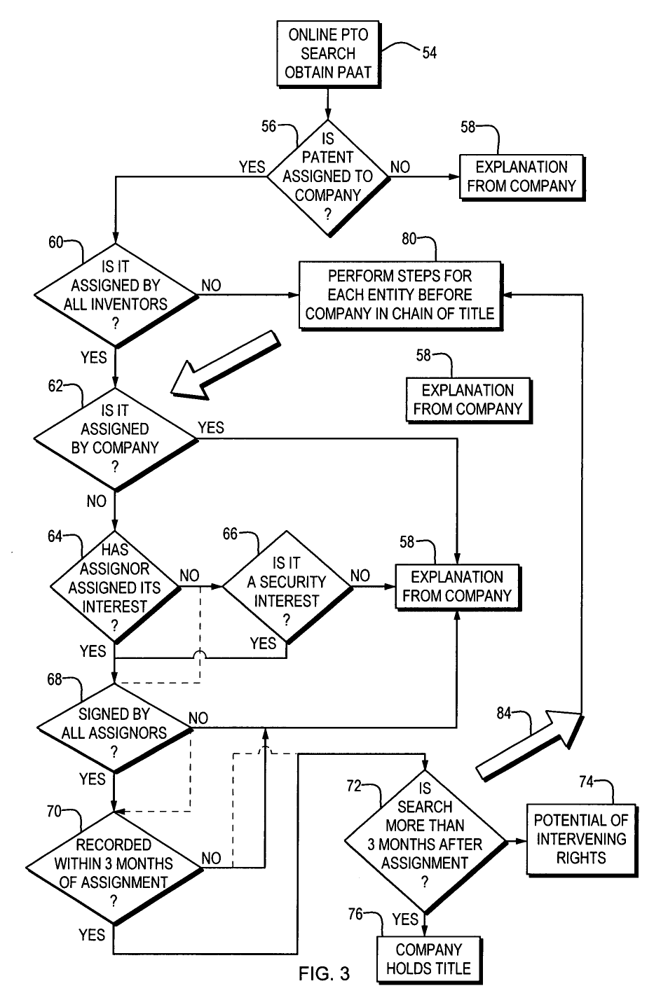

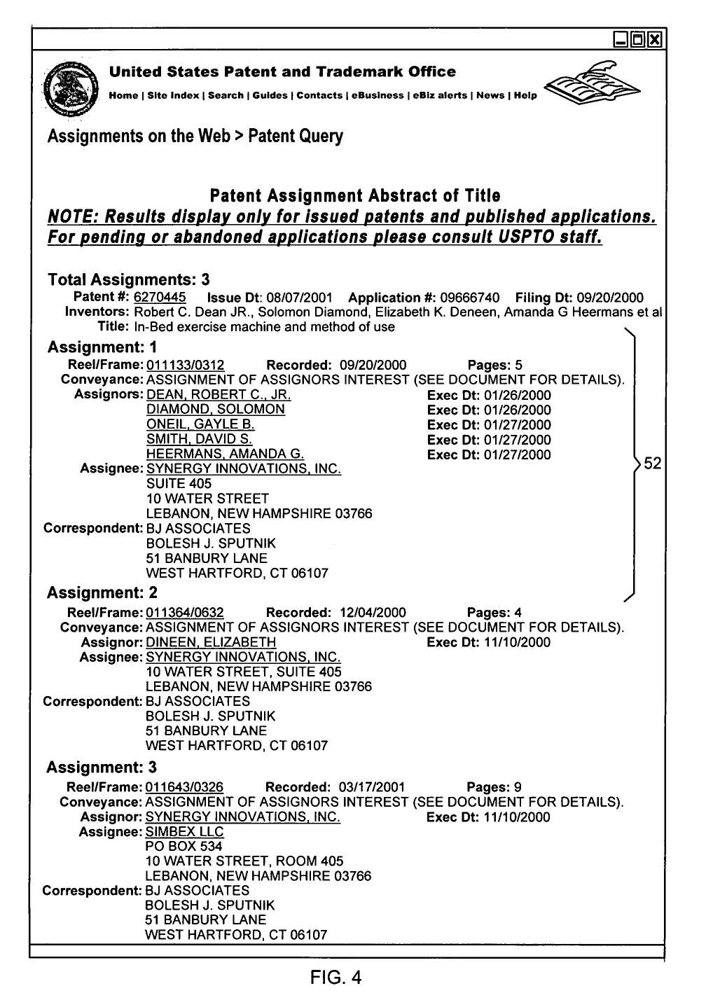

Referring to FIG. 3, a flow chart of analysis of an assignment is shown. The review system 20 connects to the USPTO assignment database server 44P, as seen in FIG. 2, regarding ownership of a patent. The financial institution 34 inputs a query into the review system regarding the party of interest, i.e., the company 30, and/or the intellectual property asset 32, the patent about which the financial institution 34 would like information. The querying system 24 in conjunction with the rights check analysis system 26, as seen in FIG. 1, using the information provided by the financial institution 34, queries the USPTO assignment database server 44P, as seen in FIG. 2, and captures the matching records as assignment history(ies) 52, as shown in FIG. 4, for the patent from the Patent Assignment Abstract of Title (PAAT) of the USPTO assignment database server 42P as represented by block 54 in FIG. 3. The querying system 24 has a fuzzy logic system to increase the likelihood of locating a record where the data is mistyped on the assignment history, such as transposed letters.

The assignment history(ies) 52 as shown in FIG. 4, the property rights data 40 of FIG. 1, is analyzed or reviewed by the rights check analysis system 26 of the review system 20. The record is reviewed to determine if the party of interest, the company 30, Acme, is an assignee of the patent as represented by block 56. If the patent is not assigned to the company 30, Acme, the information is reported back to the financial institution 34 who typically would ask for an explanation from the company 30, Acme, as represented by block 58.

If the company 30, Acme, is an assignee of the patent, the next step is to determine if the assignment is directly from all the inventors as represented by the decision diamond 60. If it is assigned directly by the inventors to the company 30, then one path is followed. If the intellectual property asset is assigned to the company 30 by a non-inventor, such as an intervening company, each of the assignments in the chain of title will need to be examined as represented by block 80 which will be explained below. As will be explained below in more detail, in addition to each assignment, each assignee/assignor will need to be examined to determine if they placed any encumbrances on the intellectual property asset through a security interest or other device.

First looking as if the assignment to the company 30, Acme, is directly from all the inventors, the next decision is if the company 30, Acme, itself has assigned the intellectual property asset 32 as represented by the decision diamond 62. If the company 30, Acme, has assigned the intellectual property asset 32, following the “yes” branch, then the company 30 therefore apparently has no interest in the underlying intellectual property asset 32, and the information is reported back to the financial institution 34 who typically would ask for an explanation as represented by block 58.

If there is no assignment by the company 30, Acme, following the “no” branch from the decision diamond 62, the next step is to determine if the assignor assigned her/his/its interest in the intellectual property 32 to the company 30, Acme, as represented by the decision diamond 62. If the assignor has not the assigned assignor's entire interest, follow the “no” branch from the decision diamond 64. The assignor may not have assigned her/his/its interest for one of several reasons. The “assignment” might not be an assignment, but rather a security interest that should have been recorded where security interests are recorded pursuant to the UCC. If the “assignment” is rather a security interest, as represented by the decision diamond 66, this information is noted and the decision tree is continued. However, if the assignment is not an assignment of the assignor's interest or a security interest following the “no” branch from decision diamond 66, the information is reported back to the financial institution 34 who typically would ask for an explanation as represented by block 58. It is recognized that these two exceptions are more likely to occur related to potential intervening assignee/assignors than from the inventors.

If the assignment to the company 30, Acme, is the entire interest of the assignor, as represented by the “yes” branch from the decision diamond 64, the next step is to determine whether the assignment is signed by all the inventors as represented by the decision diamond 68. It is recognized that on intervening assignments, the proper question would be to determine if the assignment is by all parties having an interest in the intellectual property asset. If the assignment is not by all inventors as represented by the “no” branch of the decision diamond 68, the information is reported back to the financial institution 34 who typically would ask for an explanation as represented by block 58.

If the assignment to the company 30, Acme, is from all of the interested parties, such as inventors or other assignors, as represented by the “yes” branch from the decision diamond 68, the next step is to determine if the assignment related to the underlying intellectual property asset 32 is recorded within three (3) months after execution as represented by the decision diamond 70. If the assignment is not recorded within three (3) months as represented by the “no” branch from the decision diamond 70, then the information is reported back to the financial institution 34 who typically would ask for an explanation as represented by block 58.

The relevance of three (3) months is that the U.S. Patent Law states that an assignment, grant, or conveyance shall be void as against any subsequent purchaser or mortgagee for a valuable consideration, without notice, unless it is recorded in the Patent and Trademark Office within three months from its date or prior to the date of such subsequent purchase or mortgage. It is recognized that the time period of 3 months can be adjusted in the review system 20 to coincide with current laws and regulations related to recordation and assignments and security interest.

If the assignment is recorded within three (3) months of the execution of the assignment as represented by the “yes” branch of the decision diamond 70, the next step is to determine if the search is done more than three (3) months after the assignment of the intellectual property asset 32 as represented by the decision diamond 72. If no, there is a possibility that there may be another assignment that has not been recorded resulting in intervening rights as represented by block 74. If the search is conducted more than three (3) months after the assignment of the intellectual property asset 32 as represented by the “yes” branch of the decision diamond 72, the level of confidence is high that the company 30, Acme, holds the title as represented by block 76.

Referring back to block 80 if the assignment to the company 30 is not directly from the inventors, the steps as described in relation to blocks 62-72 need to be performed for each entity before the company 30, Acme, in the chain of title as represented by the arrows 84.

As part of providing information to the customer, the review system 20 provides a report with checks “✓” or “x” to signify the results of the analysis, the decision diamonds. Therefore in one embodiment, the “no” branch of decision diamonds 64, 68, and 70 which would result in requesting explanation from the company 30, does not end the process. The next decision diamond is still reached. The arrows in phantom show the return to the next decision diamond.

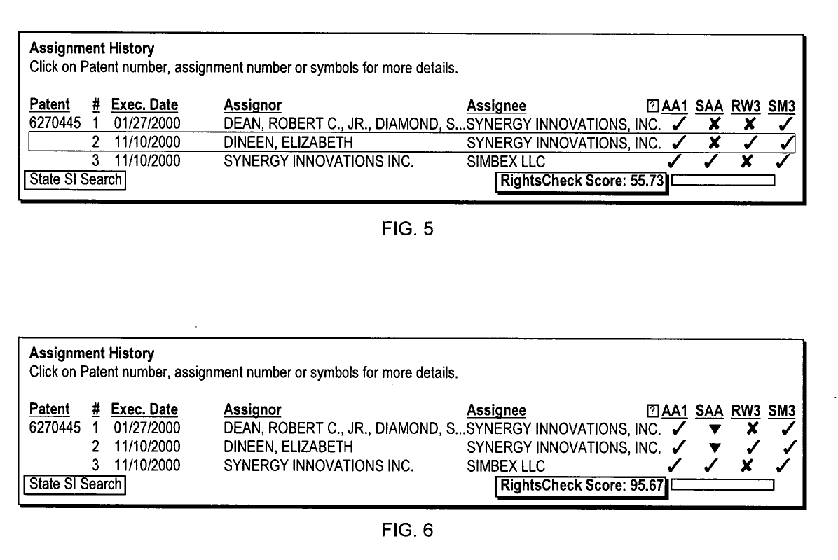

Referring to FIG. 5 a screen shot of an assignment history from the Rights Check Analysis System 26 is shown. The report shows a check “✓” or “x” placed for four decision diamonds 64, 68, 70, and 72 for each assignment reviewed.

The AAI column is for the Assignment of Assignor's Interest. This is represented by the decision diamond 64 and is “was the transaction recorded with the USPTO an ‘assignment of assignor's interest’ and not something else?” The rationale is that the Patent Act requires the recording of all ownership transfers (assignments) with the USPTO. Notice of liens or security interests—often filed incorrectly at the federal level—should be filed at the state level according to the Uniform Commercial Code in all 50 states. There is one area where a recordation that is not proper may lower the score, but the user can override, as explained below, in that the security interest may have been recorded both on the federal and state level.

The SAA column is Signed by All Assignors. This is represented by the decision diamond 68 and is “was the transaction signed by all inventors or previous assignors?” The rationale is that the Patent Act requires all inventors to sign the original patent application, after which time the inventors, or any one of them, may assign their rights to another party or parties (called the “assignees”). Assignees, in turn, may assign their rights to a third party, and so on.

The RW3 column is Recorded Within 3 Months. This is represented by the decision diamond 70 and is “was the transaction recorded within 3 months of the assignment's execution date?” The rationale is that the Patent Act requires the recording of all assignments with the USPTO within 3 months of the execution date.

The fourth column is SM3 that of Search Within 3 Months. This is represented by the decision diamond 72 and “Is the search being conducted more than 3 months after the assignment was executed?” This relates to the potential of intervening rights of someone who was assigned rights before the execution of the document and who has not recorded their document but is still in the 3 month window. The SM3 is not used in the embodiment discussed in the Rights Check Score (RCS) computation discussed below as it does not reflect any irregularity in the assignment process and is only dependent on the date when the search is conducted.

As part of the analyses of the property rights related to the intellectual property asset 32, the rights check analysis system 26 determines a score based on a set of criteria.

The Rights Check Score (RCS) Algorithm is

$$R C S = {\sum }_{i = 1}^{m} {w}^{′} ( i ) \cdot R W S ( i ) ,$$

where RCS is the composite Rights Check Score; i is the number of assignments for a patent; m is the total number assignments for a given patent; w′(i) is the normalized value of adjusted weight, w(i); and RWS(i) is the Row Weighted Score for each assignment, i. Therefore,

$${\sum }_{i = 1}^{m} {w}^{′} ( i ) = 1$$

and w(i) is a linear function:

$$w ( i ) = - a ( i - 1 ) + b and {w}^{′} ( i ) = \frac{w ( i )}{{\sum }_{i = 1}^{m} w ( i )} .$$

In one embodiment, “a” was set at −0.01 and b=0.2.

The Row Weighted Score (RWS) for each value of i is computed as

$$R W S ( i ) = {\sum }_{i = 1}^{m} k ( j ) \cdot X ( i , j )$$

Where i ranges from 1 to m, j=1, 2, or 3 and k(j) is the relative importance factor for the rules AAA, SAA, and RW3. The criteria are the Assignment of Assignor's Interest (AAI); Signed by All Assignors (SAA); and Recorded Within 3 Months (RW3).

As indicated above, SM3 (Search Within 3 Months) is not used in the RCS computation as it does not reflect any irregularity in the assignment process and is only dependent on the date when the search is conducted. It is recognized that the review system 20 can be modified to use different criteria if desired.

When a patent's assignment history is evaluated, the three rules may not be weighted the same. Some rules may have higher importance (and therefore more weight) over the others.

The table shows the quantitative weights for each rule in this example. The values of k(j) are determined using the row average of the table.

X(i,j) takes on discrete values of 0 or 100 for each i and j as follows:
x(i,1)=0, if AAI rule fails for each i
   100, if AAI rule passes for each i
x(i,2)=0, if SAA rule fails for each i
   100, if SAA rule passes for each i
x(i,3)=0, if RW3 rule fails for each i
   100, if RW3 rule passes for each i

Numerical scores of 100 for Pass and 0 for Fail are assigned. Using the relative weights for the three rules from the table, the RWS values are computed for each assignment. Since there are 3 assignments (m=3) in the example shown in FIG. 5, weights w(i) for each assignment are computed. Then these weights are normalized to get w′(i) values. Finally, the composite RCS value is computed by multiplying the normalized weight for each assignment with its RWS value. All these values are summed to get the RightsCheck score values.

| | | | | Row |
|---|---|---|---|---|
| | AAI | SAA | RW3 | Average |
| AAI | 0.2308 | 0.4118 | 0.4118 | 0.3514 |
| SAA | 0.6923 | 0.5294 | 0.5294 | 0.5837 |
| RW3 | 0.0769 | 0.0588 | 0.0588 | 0.0649 |
| Column Total | 1.0000 | 1.0000 | 1.000 | |

As indicated above, each assignment is given an adjusted weight. In the above example, the first assignment has a greater weight and the weight decreases until the most current assignment. In this example, the first assignment has a weight of 0.3509 and the last assignment has a weight of 0.3158. It is recognized that other adjusted weight systems could be used including equally weighting or a quadratic or exponential system.

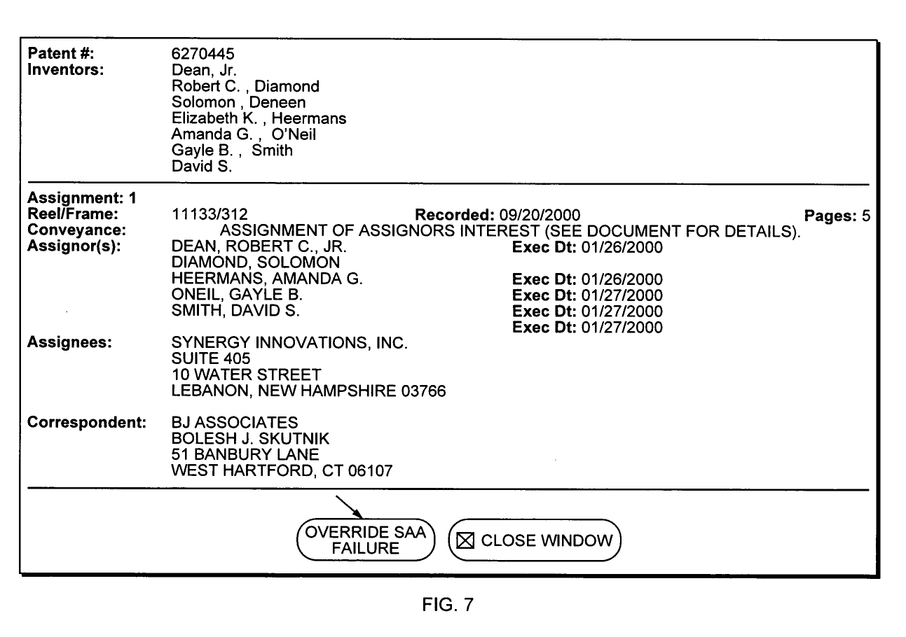

In addition, the rights check analysis system 26 of the review system 20 allows a user to override a discrete value given by the system. For example, referring to FIG. 6, the SAA column has been overridden by the user for the first two assignments. In this example both the first and second assignments were given an “x” for signed by all assignors in that neither assignment had all assignors. However, the combination of the two assignments results in assignment by all inventors, therefore the user has the option of overriding the “x” in each row of the SAA column. The triangle “▾” replaces the “x”. The RCS assigns a score of 100 in place of 0. The Rights Check Score jumps from 55.73 to 95.67. It is recognized that the system in certain embodiments may recommend the user override the results.

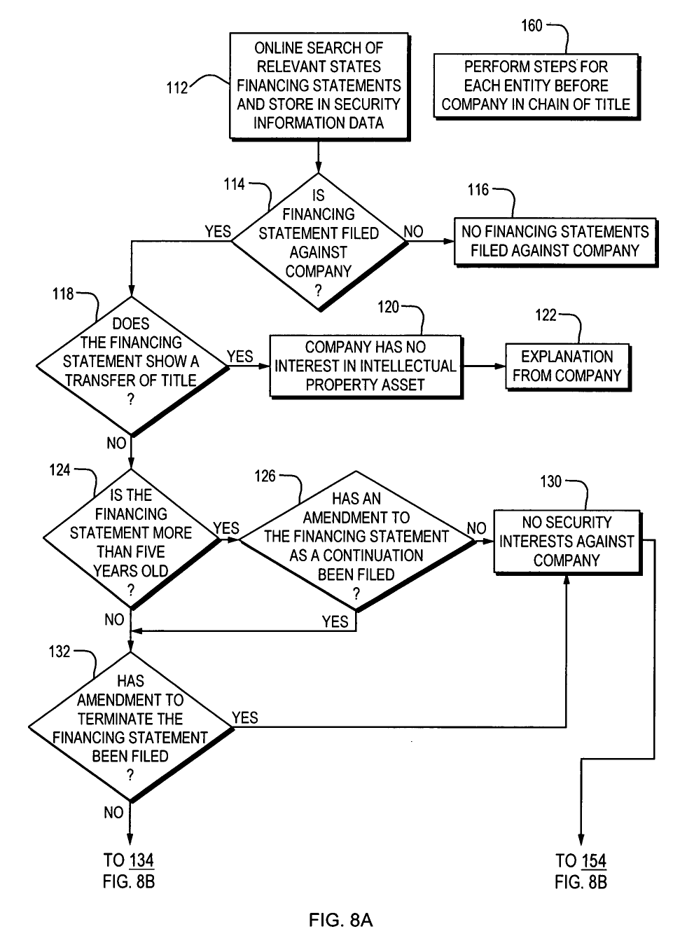

FIG. 7 shows a screen shot of an assignment summary using data from the USPTO assignment database server 44P. The review system 20 can interpret the data with ease and capture the data in the property rights database 40 of the review system 20 so that the rights check analysis system 26 can interpret the data.

In addition to determining ownership of the intellectual property asset 32, the financial institution 34 needs to determine if there are any encumbrances or security interests on the intellectual property asset 32. While a party may record a security interest that encompasses an intellectual property asset 32 with the federal government such as the U.S. Patent and Trademark Office, the security interest should be recorded and filed with the Secretary of State's Office for the state in which the debtor, the one granting the security interest, is located, as described above. For example, for the company 30, Acme, it is that state in which it was formed, Massachusetts.

The company 30, Acme, may not be as diligent in providing accurate details of the security interests it has granted. Nevertheless, it is customary for the company 30, Acme, to provide as part of the informal schedule, as seen in FIG. 1, the security interests it has granted and details of such security interests, including the assets covered by each security interest. The financial institution 34 will do a search to confirm the accuracy of the informal schedule 36 in describing both the number of security interests and the assets that they cover.

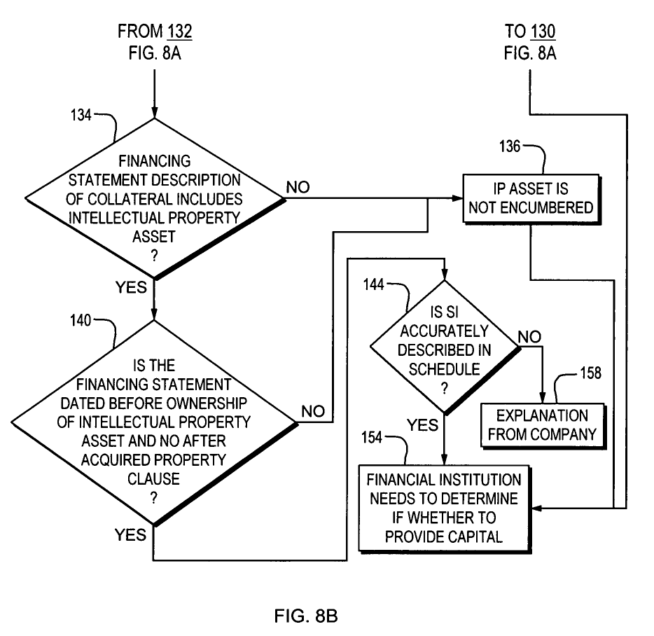

Referring to FIG. 8, a flow chart of analysis of a security interest is shown. The query system 24 of the review system 20 connects to one or more state UCC database servers 46 regarding encumbrances on an intellectual property asset 32 such as a patent. In an embodiment of the review system 20, the querying system 24 will automatically incorporate information from the property rights database 40 and examined schedule 36 unless overridden by the user such as input from the financial institution 34. For example, while the financial institution 34 may have initially inputted information on the company 30, Acme, and a reference numeral related to the intellectual property asset 32, the review system 20 will include any intervening assignor/assignee that it located during the query in the federal database server 44. It is recognized that the financial institution 34 can in the alternative provide the information regarding the party or parties of interest. The non-federal state databases 46 are generally indexed by party and therefore information regarding the intellectual property asset 32, the patent of interest, is not generally helpful.

The querying system 24 of the review system 20 has a fuzzy logic capability to allow the system 24 to locate records that may not be located if a more stringent query system is used. For example, it is more likely to locate a record where the party of interest's name is misspelled.

In addition, the review system 20 in one embodiment will recommend what non-federal databases 46 to examine. The system 20 examines the states identified with respective assignees and assignors that were gathered in the property right database 40. The user has the opportunity to accept all, some, or select on their own what non-federal databases 46 they want to search. For example, all the assignees listed in FIG. 4 are in New Hampshire. The user however may chose to search additional states such as Delaware if one of the companies is incorporated in Delaware. In that the company 30, Acme in the example, is both based and incorporated in Massachusetts, the review system 20 through its portal 22 queries the Massachusetts UCC database server 46m.

It is recognized that the review system 20 can review the data on the government database or store the data in database servers in the review system 20. If the analysis requires modification of data, the modification will occur at the review system 20 in that the government databases 38 cannot be modified and there is no desire to modify the data for analysis purposes.

Referring to FIG. 8, the search and the security information data 42, as seen in FIG. 1, are represented by block 112. The first step is to determine if any record is located and if the party of interest, the company 30, Acme, has a financing statement filed against it as represented by the decision diamond 114. If the company 30, Acme, does not have a financing statement filed against it, the “no” branch is followed from the decision diamond 114 to the block 116, and there are no encumbrances on the intellectual property assets 32 of the company 30, Acme. However, as explained below, there could be encumbrances associated with previous parties in the chain.

If there is a financing statement filed against the company 30, Acme, as represented by following the “yes” branch from the decision diamond 14, the next step is to determine if the financing statement shows a transfer of title as represented by the decision diamond 118. If the financing statement shows a transfer of title, as represented by the “yes” branch of the decision diamond 118, the company 30, Acme, does not have any interest as represented by block 120 and the information is reported back to the financial institution 34 who typically would ask for an explanation as represented by block 122.

If the financing statement shows no transfer of title, as represented by the “no” branch of the decision diamond 118, the next step is to determine if the financing statement is more than five years old as represented by the decision diamond 124. A financing statement is only effective for five years. For periods longer than five years, a financing statement amendment must be filed with the “continuation” box checked. If the financing statement is more than five years old as represented by block 126, it needs to determine if there has been an amendment to the financing statement as a continuation as represented by the decision diamond 126. If there is not an amendment as represented by the “no” branch from the decision diamond 126, there are no encumbrances or security interests on the title as represented by block 130. This is similar to block 116, not block 120, in that the company 30, Acme, still has title in the underlying intellectual property asset 32.

If there has been an amendment to the financing statement as a continuation, as represented by the “yes” branch from the decision diamond 126, it is similar to if the financing statement is less than 5 years old, as represented by the “no” branch from the decision diamond 124. In either case, the next step is to determine if an amendment has been filed to terminate the financing statement as represented by the decision diamond 132. If an amendment has been filed to the financing statement to terminate the security interest as represented by the “yes” branch from the decision diamond 132, there are no encumbrances or security interests on the title as represented by block 130.

Still referring to FIG. 8, if no amendment has been filed to the financing statement to terminate the security interest as represented by the “no” branch from the decision diamond 132, the next step is to determine whether the financing statement includes, as part of the description of the collateral the intellectual property asset such as the patent portfolio, in this example as represented the decision diamond 134.

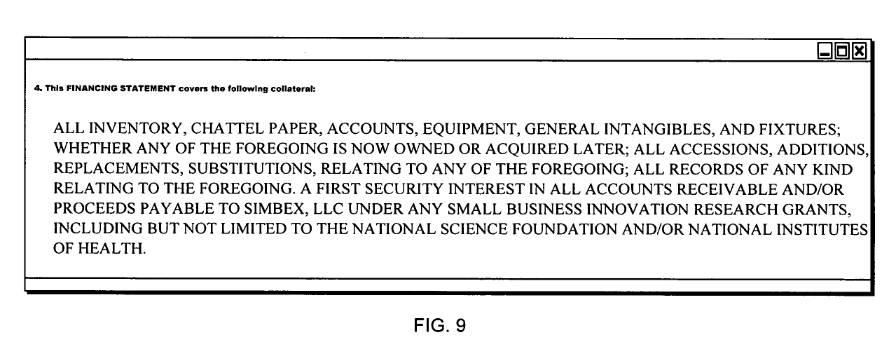

A general description of collateral, an example of which is attached hereto as FIG. 9, that includes patents, general intangible or even business assets, includes the intellectual property asset 32. A financing statement that describes only a specific piece of equipment or accounts receivable, for example, does not include the intellectual property asset 32. If the Patent or Application is not described in the financing statement, no security interest attaches to the Patent.

If the financing statement does not include as part of the description of the collateral intellectual property assets 32 as represented by the “no” branch of the decision diamond 134, there is no encumbrance or security interest on the title as represented by block 136.

If the financing statement does include as part of the description of the collateral intellectual property assets 32 as represented by the “yes” branch of the decision diamond 134, the next step is to determine if 1) the financing statement is dated before or after the company 30, Acme, acquired rights in the intellectual property assets 32 and 2) if the financing statement has an “after acquired property clause” as represented by the decision diamond 140. If the financing statement is 1) dated before the company 30, Acme, acquired rights in the intellectual property assets 32 and 2) the financing statement does not have an “after acquired property clause,” as represented by the “no” branch from the decision diamond 140, there is no encumbrance or security interest on the title as represented by block 136.

If the financing statement is 1) dated after the company 30, Acme, acquired rights in the intellectual property assets 32 or 2) the financing statement does have an “after acquired property clause,” as represented by the “yes” branch from the decision diamond 140, the next step is to determine if the security interest is accurately described in the informal schedule 36, as shown in FIG. 1. The company 30, Acme, as part of attempting to get funding from the financial institution 34 has provided an informal schedule 30 of the intellectual property assets 32 that the company 30, Acme, is using to obtain financing. If the security interest is not accurately described in the informal schedule as represented by as represented by the “no” branch of decision diamond 144, an explanation is required from the company 30, Acme as represented by block 158. If the security interest is accurately described in the informal schedule as represented by the “yes” branch of the decision diamond 144, the next step after block 160 as described below is completed, is for the financial institution 34 to determine whether to provide capital to the company 30, Acme, as represented by block 154. Blocks 130 and 136 likewise lead to block 154.

As indicated above, in addition to performing the steps as generally described in blocks 118-154 for the company 30, Acme, the financial institution 34 needs to perform the steps described above in relation to blocks 118-146 for each entity that holds title to any of the intellectual property assets 32 prior to the company 30, Acme; this is represented by block 160.

This additional searching is required because assignments, or other transfers of title, of intellectual property assets 30, such as patents or patent applications, are subject to security interests, or other encumbrances. In other words, if a third party company, the ABC Company, grants a security interest in a patent to a bank and subsequently assigns that patent to the company 30, Acme, the assignee, the company 30, Acme, takes subject to the security interest, or other encumbrance.

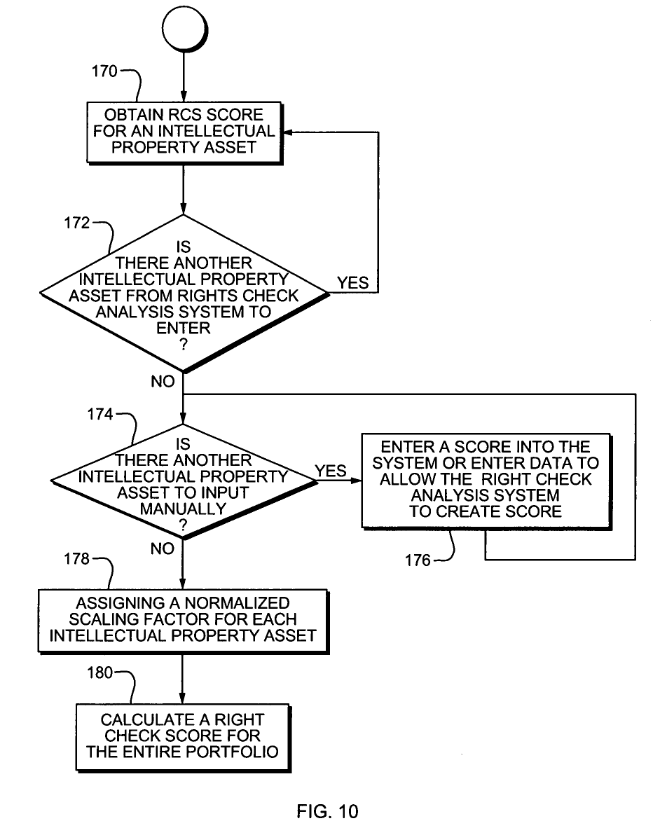

Referring to FIG. 10, a schematic of providing a Rights Check Score for multiple intellectual property assets is shown. The company 30, Acme, may have a portfolio of several intellectual property assets that it wants to use in raising capital. The financial institution 34 may want to value the entire portfolio together. A Rights Check Score is obtained for an intellectual property asset as represented by block 170. The system determines if there is another intellectual property asset 32 to enter from the rights check analysis system 26 in the decision diamond 172. If there is another, the system returns to block 170 to obtain the score.

When there are no more intellectual property assets in the rights check analysis system 26, the next decision is what other intellectual property assets to input manually as represented by the decision diamond 174. One example would be a patent application that has not been published and therefore is not available on the USPTO assignment database server 42P. The information can either be inputted manually into the review system 20 so that the rights check analysis system 26 can determine a RCS or the user can assign a RCS as represented by block 176.

Each intellectual property asset 32 needs a scaling factor. The review system 20 can assign a scaling factor on numerous factors or the user can assign a scaling factor as represented by block 178 In one embodiment, the default is to have each asset have the same scaling factor. In another embodiment, the first patent application and any divisional or continuation application and resulting patents have the same scaling factor. Any patent application that is a continuation-in-part has a decreasing scaling factor. The scaling factor could be based on the length of term left if the patents were not from the same family. It is recognized that there are numerous scaling systems.

Block 180 represents calculating the RCS for the entire portfolio.

While the principles of the present invention have been described herein, it is to be understood by those skilled in the art that this description is made only by way of example and not as a limitation as to the scope of the invention. Other embodiments are contemplated within the scope of the present invention in addition to the preferred embodiments shown and described herein. Modifications and substitutions by one of ordinary skill in the art are considered to be within the scope of the present invention, which is not to be limited except by the following claims.

It is recognized that the review system 20 reviews and analyzes material that is available through the portal 22, that is the federal database servers 42 and the non-federal state database servers 44 as seen in FIG. 2. The financial institution 34 may want to obtain a copy of the underlying document such as an assignment from the company 30, Acme, or the recording of the document, such as the U.S. Patent and Trademark Office.

It is recognized that as technologies evolve and/or the outside databases 38 add or change formats, the review system 20 may desire to or will be required to be modified to query, gather, and analyze the data. Databases and in particular the non-federal databases may vary in format from government agency to government agency. The system 20 needs to recognize various formats. The review system 20 can include systems to convert images into readable characters. In addition, the system can include systems to differentiate between data and recordation stamps.

The invention claimed is:

1. An assessment method of reviewing ownership of and encumbrances on intellectual property, the assessment method comprising:
reviewing a document associated with the recordation of transfer of ownership of an intellectual property asset; and
assigning a value based on whether a criteria is met or is not met related to the transfer of ownership of an intellectual property asset.

2. An assessment method of claim 1 wherein the intellectual property is a patent or patent application.

3. An assessment method of claim 1 wherein only documents recorded with a federal agency are evaluated.

4. An assessment method of claim 1 wherein the evaluation is done on a specific set of criteria.

5. An assessment method of claim 4 wherein the specific set of criteria includes
determining if the intellectual property asset is assigned to a party of interest;
determining if all the inventors assigned the intellectual property asset directly to the party of interest; and
determining if the document associated with the recordation of transfer of ownership of the intellectual property asset was recorded within a specific time period.

6. An assessment method of claim 5 wherein the specific set of criteria further includes determining if a party assigned their interest.

7. An assessment method of claim 4 wherein the results of at least one criteria are capable of being manually overridden by a user.

8. An assessment method of claim 5 further comprising
assigning a value based on whether at least one other criteria is met or not related to the transfer of ownership of an intellectual property asset; and
summing the values of a plurality of criteria to arrive at a score.

9. An assessment method of claim 1 further comprising reviewing at least one additional document associated with the recordation of transfer of ownership of the intellectual property asset, and determining the score based on the average of the score for each document.

10. An assessment method of claim 9 wherein a scaling factor is assigned to each document reviewed.

11. An assessment method of claim 10 wherein the scaling factor is identical for each document.

12. An assessment method of claim 10 wherein the scaling factor is linear and the oldest document in the chain has the highest value and the newest document in the chain has the lowest value.

13. An assessment method of claim 10 wherein the scaling factor is quadric or exponential.

14. An assessment method of claim 1 wherein at least two intellectual property assets are evaluated and the score for each of the intellectual property assets is aggregated to give a portfolio score.

15. An assessment method of claim 14 wherein each intellectual property asset has a scaling factor associated with the asset.

16. An assessment method of claim 15 wherein the value of the scaling factor is dependent on the relationship of the intellectual property asset to the initial filed intellectual property asset.

17. An assessment method of claim 15 wherein manually entering data each of the criteria has its own scaling constant.

18. A system for reviewing data comprising:
an input device for receiving a request for information from a querying device for assessment of the information;
a querying mechanism for requesting and receiving information from at least one government entity database; and
an output device for presenting at least some of the information gathered from the at least one government entity database.

19. A system of claim 18 wherein the information from the querying device is related to ownership of and encumbrances on intellectual property assets.

20. A system of claim 19 wherein the request is related to a U.S. patent or patent application and the at least one government entity database includes the U.S. Patent and Trademark Office patent assignment database server.

21. A system of claim 19 wherein the request is related to a U.S. trademark or trademark application and the at least one government entity database includes the U.S. Patent and Trademark Office trademark assignment database server.

22. A system of claim 9 wherein the request is related to a property that has an underlying federal copyright registration and the at least one government entity database is the U.S. Copyright Office Registrations and Documents database server.

23. A system of claim 18 wherein the querying mechanism includes fuzzy logic for increasing the likelihood of gathering all relevant information from the at least one government entity database.

24. A system of claim 18 wherein the at least one government entity database includes at least one database controlled by the federal government and at least one database controlled by a non-federal agency.

25. A system of claim 24 wherein the at least one government entity database controlled by a non-federal agency is a UCC database of a state organization.

26. A system of claim 25 wherein the at least one government entity database controlled by the federal government is the assignment database of the U.S. Patent and Trademark Office.

27. A system of claim 18 wherein the querying mechanism requests information based on a field of data.

28. A system of claim 27 wherein the field of data searched is the inventor field.

29. A system of claim 27 wherein the field of data searched is the intellectual property asset reference number field.

30. A system of claim 27 wherein the field of data searched is the assignee field.

31. A system of claim 27 wherein the field of data searched is the assignor field.

32. A system of claim 17 wherein the information received from the at least one government entity database is stored in a database for analysis.

33. A system of claim 17 wherein the information received from the at least one government entity database is in an image format.

34. A system of claim 33 wherein the information received is converted from the image format to a character format.

35. A system for gathering and reviewing ownership of and encumbrances on intellectual property comprising:
an input device for receiving a query from a querying device, the query in the form of a property identification number or a party;
a querying mechanism for requesting and receiving information from at least one government entity database based on the query;
an analyzing mechanism for analyzing the information from the at least one government entity database; and
an output device for presenting the information and the analyses of the information.

36. A system of claim 35 wherein the intellectual property is a patent or patent application.

37. A system of claim 36 wherein the querying mechanism includes fuzzy logic for increasing the likelihood of gathering all relevant information from the at least one government entity database.

38. A system of claim 37 wherein the analyzing mechanism evaluates the information on a specific set of criteria.

39. A system of claim 38 wherein the specific set of criteria includes:
determining if the intellectual property asset is assigned to a party of interest;
determining if all the inventors assigned the intellectual property asset directly to the party of interest; and
determining if the document associated with the recordation of transfer of ownership of the intellectual property asset was recorded within a specific time period.

40. A system of claim 39 wherein the results of at least one criteria are capable of being manually overridden by a user.

41. A system of claim 39 wherein the queried information (not on the government computer) is capable of being modified and analyzed again.

42. A system of claim 40 wherein the analyzing mechanism assigns a value based on whether at least one other criteria is met or not related to the transfer of ownership of an intellectual property asset; and sums the values of a plurality of criteria to arrive at a score.

43. A system of claim 42 where the analyzing mechanism reviews at least one additional document associated with the recordation of transfer of ownership of the intellectual property asset, and determines the score based on the average of the score for each document.

44. A system of claim 43 wherein a scaling factor is assigned to each document reviewed.

45. A system of claim 44 wherein the scaling factor is linear and the oldest document in the chain has the highest value and the newest document in the chain has the lowest value.

46. A system of claim 45 wherein the score (RCS) is represented by
$$R C S = {\sum }_{i = 1}^{m} {w}^{′} ( i ) \cdot R W S ( i ) ,$$
wherein
i is the number of assignments for a patent;
m is the total number assignments for a given patent;
w′(i) is the normalized value of adjusted weight, w(i); and
RWS(i) is the Row Weighted Score for each assignment, i. where
$$R W S ( i ) = {\sum }_{i = 1}^{m} k ( j ) \cdot X ( i , j )$$
wherein
k(j) is the relative importance factor for the criteria; and
X(i,j) takes on discrete values of 0 or 100 for each i and j.

47. A system of claim 46 wherein w(i)=−a(i−1)+b.

48. A system of claim 47 wherein a=−0.01 and b=0.2
